(19) United States
(12) Patent Application Publication
(10) Pub. No.: US 2026/0329063 A1
(43) Pub. Date: Oct. 22, 2026

(54) MICROSCOPY SYSTEM AND METHOD FOR CONSTRUCTING A SINGLE-MOLECULE FLUORESCENCE IMAGE

(71) Applicant: National Central University, Taoyuan City (TW)

(72) Inventors: Fan-Ching Chien, Taoyuan City (TW); Jian-Zong Lai, Bukit Mertajam (MY)

(21) Appl. No.: 19/182,617

(22) Filed: Apr. 18, 2025

(51) Int. Cl. G02B 21/00; H04N 23/56

(52) U.S. Cl. CPC G02B 21/0076; G02B 21/0032; G02B 21/0044; G02B 21/0048; H04N 23/56

(57) ABSTRACT

A microscopy system includes an ultrafast laser; a half-wave plate coupled to the ultrafast laser; a linear polarizer coupled to the half-wave plate; a shutter coupled to the linear polarizer; a first mirror coupled to the shutter; a scanning module coupled to the first mirror; a collimating lens coupled to the scanning module; an objective lens coupled to the collimating lens; a dichroic mirror coupled to the objective lens; a short-pass emission filter coupled to the dichroic mirror; an imaging lens coupled to the short-pass emission filter; a pair of cylindrical lenses coupled to the imaging lens; and a camera coupled to the pair of cylindrical lenses. A method for constructing a single-molecule fluorescence image includes capturing the fluorescence image of a blinking fluorophore-labeled sample by the microscopy system; and constructing the single-molecule fluorescence image of the blinking fluorophore-labeled sample. The fluorescence image is a blinking fluorescence image.

### BACKGROUND OF THE INVENTION

### 1. Field of the Invention

The present disclosure relates to a microscopy imaging approach, and more particularly, to temporal-focusing multiphoton excitation single-molecule localization microscopy imaging approach for achieving single-molecule fluorescence imaging of blinking fluorophore-labeled samples.

### 2. Description of the Prior Art

Single-molecule localization microscopy (SMLM) has achieved fluorescence imaging beyond the diffraction limit, and also provides quantitative information, including copy number, clustering, and colocalization of proteins, depending on the site and number of localization events estimated from time-lapse images of blinking fluorescence. Quantitative microscopy has presented many significant results for exploring the biophysical and biochemical processes in cell biology. Modified SMLM systems are demonstrated to provide higher-dimensional information on the fluorescence spectrum, fluorescence lifetime, and orientation of each localization molecule. Nanoscale axially resolved methods are used to improve the axial resolution of SMLM to 10 to 50 nm for realizing three-dimensional (3D) super-resolution imaging. However, the axial detection range of 3D SMLM without z-axis scanning is approximately 0.3 to 3 μm. Therefore, to visualize the entire volume of thick biospecimens, axial imaging is sequentially performed to record all blinking events at every depth, rendering a 3D SMLM image. In recent studies, 3D SMLM, adaptive optics, and active astigmatism have been combined to increase the imaging depth of thick biospecimens through the reduction of aberrations. However, concerns have been raised regarding the imaging of thick biospecimens through the single-photon excitation (SPE) approach in conventional 3D SMLM. These concerns mainly pertain to the reduced imaging depth within turbid media, the increased fluorescence background from out-of-focus regions, and the reduction of the number of localization molecules as a result of fluorophore photobleaching in out-of-focus regions, which remain unlocalized.

Light-sheet illumination is used to reduce the photobleaching effect of unlocalized molecules and increase the utilization rate of the limited photon budget in SMLM imaging of thick biospecimens. However, the practical implementation of light-sheet illumination is complicated by the requirement of two objective lenses, especially those with large numerical apertures, that are set in orthogonal alignment for excitation and detection. In addition, special pretreatment and mounting are required to enable the excitation light to laterally penetrate tissue specimens. Multiphoton excitation (MPE) fluorescence microscopy has emerged as a powerful technique for deep tissue imaging, offering advantages in terms of penetration depth, intrinsic optical sectioning, and nominal photobleaching. However, conventional spatial-focusing MPE fluorescence microscopy lacks the temporal resolution for capturing the rapid blinking of fluorophores in SMLM imaging. As an alternative, temporal-focusing MPE (TFMPE) microscopy recombines all the frequencies of the laser pulse in phase on the objective focal plane through a diffraction grating and the 4f configuration of collimating and objective lenses, resulting in a laser pulse with high peak power and a short pulse width, and enabling wide-field and optical section fluorescence excitation on the objective focal plane. Overall, capturing MPE fluorescence images with a high-speed camera considerably increases the temporal resolution of images, thus meeting the requirements for recording the blinking fluorescence of fluorophores. However, despite advancements, the spatial resolution of TFMPE fluorescence imaging remains constrained by the diffraction limit.

In view of the foregoing, there is an unmet need in the art to provide a novel SMLM imaging approach to overcome the drawbacks faced by existing prior art.

### SUMMARY OF THE INVENTION

To solve the aforementioned problems, the present disclosure provides a microscopy system. The microscopy system includes: an ultrafast laser for emitting incident light beam; a half-wave plate coupled to the ultrafast laser and used to adjust power of the ultrafast laser; a linear polarizer coupled to the half-wave plate and used to adjust the power of the ultrafast laser; a shutter coupled to the linear polarizer; a first mirror coupled to the shutter; a scanning module coupled to the first mirror; a collimating lens coupled to the scanning module and used to form a 4f configuration with an objective lens; the objective lens coupled to the collimating lens for focusing and recombining the diffraction light beam to excite a blinking fluorescence signal of a sample and collecting the blinking fluorescence signal of the sample; a dichroic mirror coupled to the objective lens and used to filter the fluorescence signal; a short-pass emission filter coupled to the dichroic mirror and used to filter the fluorescence signal; an imaging lens coupled to the short-pass emission filter and used to allow the fluorescence signal being imaged; a pair of cylindrical lenses coupled to the imaging lens and used to induce an astigmatic effect to extract an axial position of a fluorophore; and a camera coupled to the pair of cylindrical lenses and used to capture a blinking fluorescence image. The sample may include the fluorophore. The scanning module includes a scanning mirror; and a diffraction grating coupled to the scanning mirror for generating a diffraction light beam. The scanning module is used to adjust the incident light beam size of the laser and the incident light beam angle.

The present disclosure further provides a method for constructing a single-molecule fluorescence image, including: capturing the fluorescence image of a blinking fluorophore-labeled sample by a microscopy system; and constructing the single-molecule fluorescence image of the blinking fluorophore-labeled sample. The fluorescence image may be a blinking fluorescence image. The microscopy system may include: an ultrafast laser for emitting incident light beam; a half-wave plate coupled to the ultrafast laser and used to adjust the power of the ultrafast laser; a linear polarizer coupled to the half-wave plate and used to adjust the power of the ultrafast laser; a shutter coupled to the linear polarizer; a first mirror coupled to the shutter; a scanning module coupled to the first mirror; a collimating lens coupled to the scanning module and used to form a 4f configuration with an objective lens; the objective lens coupled to the collimating lens for focusing and recombining the diffraction light beam to excite a blinking fluorescence signal of a blinking fluorophore-labeled sample and collecting the blinking fluorescence signal of the blinking fluorophore-labeled sample; a dichroic mirror coupled to the objective lens and used to filter the blinking fluorescence signal; a short-pass emission filter coupled to the dichroic mirror and used to filter the blinking fluorescence signal; an imaging lens coupled to the short-pass emission filter and used to allow the blinking fluorescence signal being imaged; a pair of cylindrical lenses coupled to the imaging lens and used to induce an astigmatic effect to extract an axial position of a fluorophore; and a camera coupled to the pair of cylindrical lenses and used to capture the blinking fluorescence image. The scanning module may include a scanning mirror; and a diffraction grating coupled to the scanning mirror for generating a diffraction light beam. The scanning module may be used to adjust the incident light beam size of the laser and the incident light beam angle.

The objectives of the present disclosure will become readily understandable to those of ordinary skill in the art after reading the following detailed description of the embodiments that are illustrated in the various figures and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a TFMPE-SMLM system setup according to at least one embodiment of the present disclosure.

FIG. 2 is a schematic diagram of a line scanning-TFMPE-SMLM system setup according to at least one embodiment of the present disclosure.

FIG. 3A is a time trace image of TPE fluorescence signals from a single HEtetTFER fluorophore at pH 7.0 for TPE fluorescence blinking measurements conducted using the TFMPE-SMLM system according to at least one embodiment of the present disclosure (the insets show TPE fluorescence images and the chemical structure of HEtetTFER in the signals of fluorescence-on and fluorescence-off (scale bar: 300 nm)).

FIG. 3B is a time trace image of TPE fluorescence signals from Atto 488 under temporal-focusing multiphoton excitation according to at least one embodiment of the present disclosure.

FIG. 3C is a time trace image of TPE fluorescence signals from Nile Red under temporal-focusing multiphoton excitation according to at least one embodiment of the present disclosure.

The upper left panel of FIG. 4 is an image of measurement results of spectrum distribution for the ultrafast laser beam at the back focal plane of the objective in the TFMPE-SMLM system according to at least one embodiment of the present disclosure (the red circle indicates the objective's back aperture, with a 5.4 mm diameter).

The lower left panel of FIG. 4 is an image of simulation results of spectrum distribution for the ultrafast laser beam at the back focal plane of the objective in the TFMPE-SMLM system according to at least one embodiment of the present disclosure (the red circle indicates the objective's back aperture, with a 5.4 mm diameter).

The upper middle panel of FIG. 4 is an image of TPE fluorescence intensity profiles along the axial direction measured for a fluorescence nanosphere in PBS (blue line) and glycerol (red line) solutions at an excitation wavelength of 840 nm according to at least one embodiment of the present disclosure (the dashed lines denote the fitting curves used to determine axial excitation confinement, obtained using a spatially chirped beam fitting equation).

The lower middle panel of FIG. 4 is an image of simulation results of axial normalized TPE fluorescence intensity profiles through TFMPE fluorescence imaging for specimens with refractive indexes of 1.33 (blue line) and 1.47 (red line) according to at least one embodiment of the present disclosure.

The upper right panel of FIG. 4 is an image of fluorescence intensities of HEtetTFER-agarose gel specimens obtained through sequential axial imaging with SPE (red line) and TFMPE (blue line) according to at least one embodiment of the present disclosure (the excitation wavelengths for SPE and TFMPE are 473 and 840 nm, respectively, obtained by 3 measurements and normalized according to the initial intensity).

The lower right panel of FIG. 4 is a schematic illustration of comparison for the excitation regions of the HEtetTFER-labeled Aβ peptide deposits in thick specimens using conventional wide-field SPE and TFMPE approaches, used to perform sequentially axial imaging for rendering 3D SMLM images according to at least one embodiment of the present disclosure.

The upper left panel of FIG. 5 is a wide-field SPE fluorescence image of Aβ deposits in the brain coronal section of 5×FAD transgenic mouse with 10× objectives according to at least one embodiment of the present disclosure (scale bar: 150 μm).

The upper right panel of FIG. 5 is a wide-field SPE fluorescence images of Aβ deposits in the brain coronal section of 5×FAD transgenic mouse with 20× objectives according to at least one embodiment of the present disclosure (scale bar: 80 μm).

The lower left panel of FIG. 5 is a wide-field SPE fluorescence images of Aβ deposits in the brain coronal section of 5×FAD transgenic mouse with 60× objectives according to at least one embodiment of the present disclosure (scale bar: 15 μm).

The lower right panel of FIG. 5 is a wide-field SPE fluorescence images of Aβ deposits in the brain coronal section of 5×FAD transgenic mouse with 60× objectives according to at least one embodiment of the present disclosure (scale bar: 15 μm).

FIG. 6 is a 3D TFMPE-SMLM image of the filaments of HEtetTFER-labeled Aβ peptides in the brain section of a 5×FAD transgenic mouse with amyloid pathological features of AD according to at least one embodiment of the present disclosure (the color coding indicates the z position; scale bar: 3 μm).

The left panel of FIG. 7 is a magnified view of the orange dashed box in FIG. 6 according to at least one embodiment of the present disclosure (scale bar: 500 nm).

The middle panel of FIG. 7 is a 3D TFMPE-SMLM fluorescence image of y′-z cross-section indicating the depth difference of adjacent Aβ fibril bundles in the orange dashed box in FIG. 6 according to at least one embodiment of the present disclosure (scale bar: 500 nm).

The right panel of FIG. 7 is an equivalent TFMPE fluorescence image of y′-z cross-section indicating the depth difference of adjacent Aβ fibril bundles in the orange dashed box in FIG. 6 according to at least one embodiment of the present disclosure (scale bar: 500 nm).

The left panel of FIG. 8 is an image of axial cross-section of Aβ fibril bundles along the white line (x′-x′) in FIG. 6 according to at least one embodiment of the present disclosure (scale bar: 200 nm).

The middle panel of FIG. 8 is an image of axial cross-section of Aβ fibril bundles along the white line (x″-x″) in FIG. 6 according to at least one embodiment of the present disclosure (scale bar: 200 nm).

The right panel of FIG. 8 is an image showing the intensity profiles of Aβ fibril bundles according to at least one embodiment of the present disclosure (left portion: along the white dashed boxes in the left panel of FIG. 8; right portion: along the white dashed boxes in the middle panel of FIG. 8).

The left panel of FIG. 9 is an image of distribution of the lateral and axial widths of Aβ fibril bundles according to at least one embodiment of the present disclosure.

The right panel of FIG. 9 is a 3D-rendered image from the z stack of the region enclosed by the white dashed box in FIG. 6 (scale bar: 1 μm).

### DETAILED DESCRIPTION

The following descriptions of the embodiments illustrate implementations of the present disclosure, and those skilled in the art of the present disclosure can readily understand the advantages and effects of the present disclosure in accordance with the contents herein. However, the embodiments of the present disclosure are not intended to limit the scope of the present disclosure. The present disclosure can be practiced or applied by other alternative embodiments, and every detail included in the present disclosure can be changed or modified in accordance with different aspects and applications without departing from the essentiality of the present disclosure.

The features such as a ratio, structure, and dimension shown in drawings accompanied with the present disclosure are simply used to cooperate with the contents disclosed herein for those skilled in the art to read and understand the present disclosure, rather than to limit the scope of implementation of the present disclosure. Thus, in the case that does not affect the purpose of the present disclosure and the effect brought by the present disclosure, any change in proportional relationships, structural modification, or dimensional adjustment should fall within the scope of the technical contents disclosed herein.

As used herein, “comprising” (and any variant or conjugation thereof, such as “comprise” or “comprises”), or “including” (and any variant or conjugation thereof, such as “include” or “includes”) a specific element, unless otherwise specified, may include other elements such as components, structures, regions, modules, units, portions, devices, systems, or connection relationships rather than exclude those elements.

The terms “between” described herein are simply used to clarify the embodiments of the present disclosure, rather than used to limit the scope of implementation of the present disclosure. Adjustments, interchanges, and alteration of relative positions and relationships thereof should be considered within the scope of implementation of the present disclosure if the technical contents of the present disclosure are not substantially changed.

The terms “first,” “second,” “third,” “fourth,” etc., used herein are simply used to describe or distinguish elements such as components, structures, regions, modules, units, portions, devices, or systems, rather than used to limit the scope of implementation of the present disclosure or to limit the spatial order of the elements. In addition, unless otherwise specified, the singular forms “a/an” and “the” used herein also include plural forms, and the terms “or” and “and/or” used herein are interchangeable.

The terms “connected,” “connecting,” “disposed,” and “disposing,” used herein are used to describe a plurality of elements connected together directly or indirectly. “Direct connection” is used to describe a plurality of elements connected together upon direct contact; and “indirect connection” is used to describe a plurality of elements connected together via at least one connecting component. For example, the terms “connected,” “connecting,” “disposed,” and “disposing,” used herein may be accomplished by conjugation, binding, bonding, adhesion, insertion, clamping, attachment, embedding, integrated molding, gluing, gumming, cementing or any combination thereof. In at least one of the embodiments of the present disclosure, the plurality of elements is “detachable” connected, i.e., the plurality of elements may be detached and separated after being connected.

As used herein, the term “about” generally referring to the numerical value meant to encompass variations of ±20%, ±10%, ±5%, ±1%, ±0.5%, or ±0.1% from a given value or range. Such variations in the numerical value may occur by, e.g., the experimental error, the typical error in measuring or handling procedure for making compounds, compositions, concentrates, or formulations, the differences in the source, manufacture, or purity of starting materials or ingredients used in the present disclosure, or like considerations. Alternatively, the term “about” means within an acceptable standard error of the mean when considered by a person having ordinary skill in the art. Unless otherwise expressly specified, all of the numerical ranges, amounts, values and percentages such as those for quantities of materials, durations of time periods, temperatures, operating conditions, ratios of amounts, and the likes disclosed herein should be understood as modified in all instances by the term “about.”

As used herein, the terms “biotissue specimens,” “tissue specimens,” “biospecimen” and “specimen” are used interchangeably.

As used herein, the terms “blinking fluorophore” include xanthene-based fluorophore and rhodamine-derivative fluorophore, but the present disclosure is not limited thereto.

In some embodiments of the present disclosure, the blinking fluorescence produced by fluorescence molecules may be generated by at least one approached selected from the group consisting of spontaneously blinking fluorescence, photoswitchable fluorescence, and transient binding.

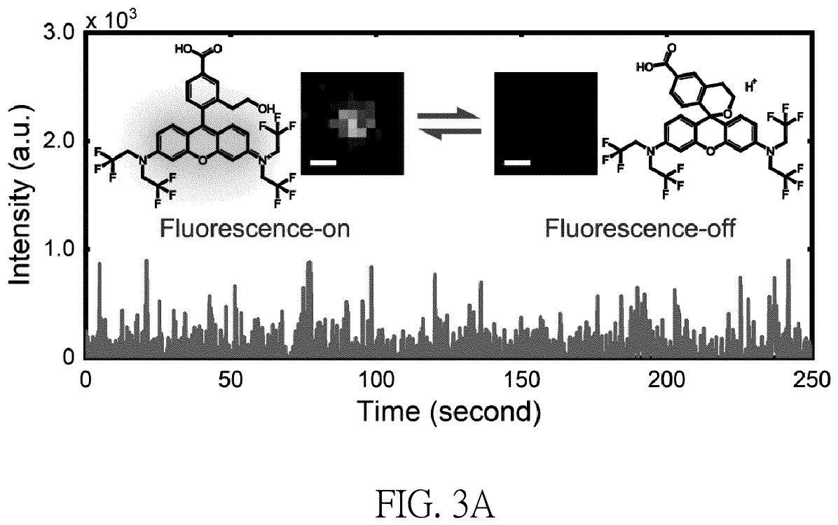

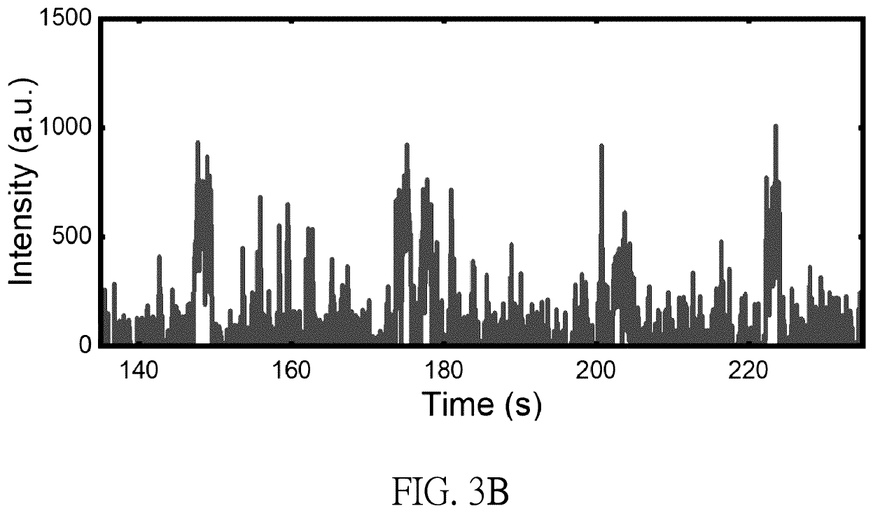

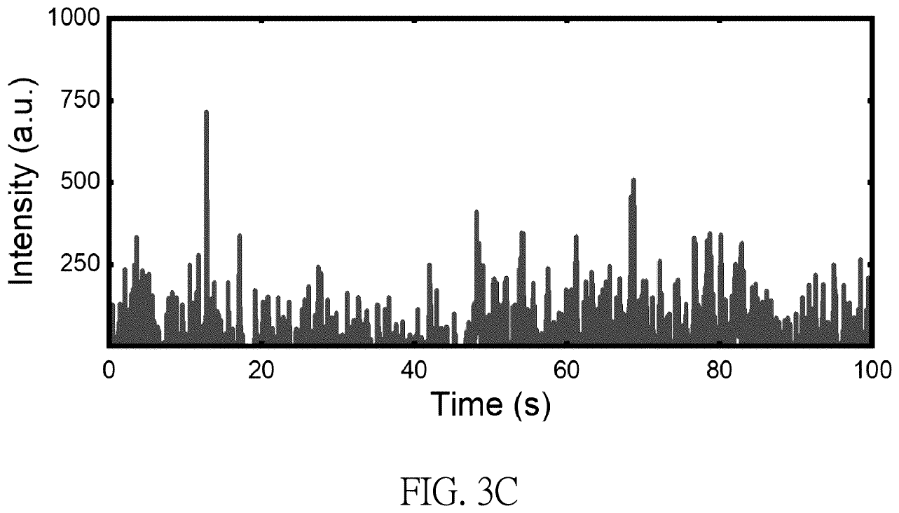

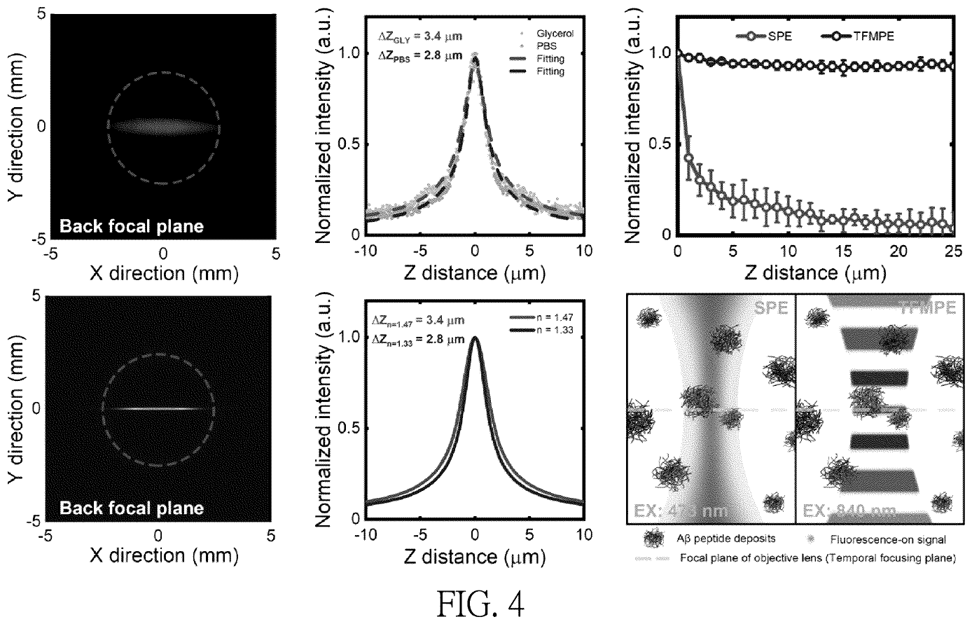

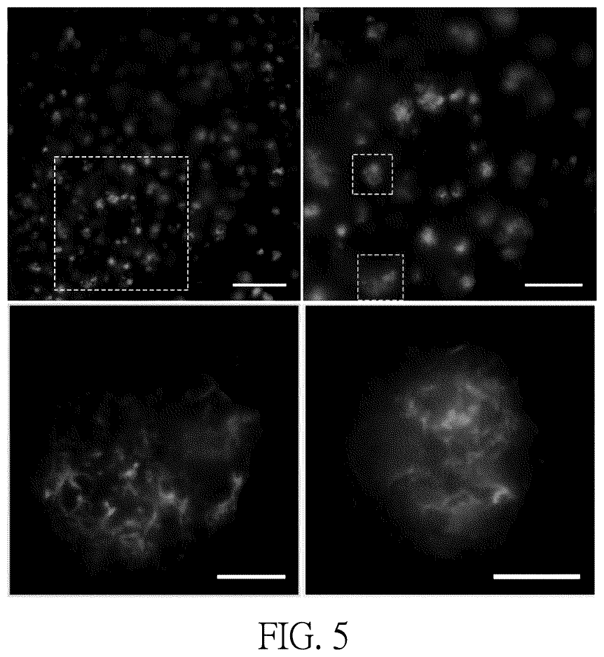

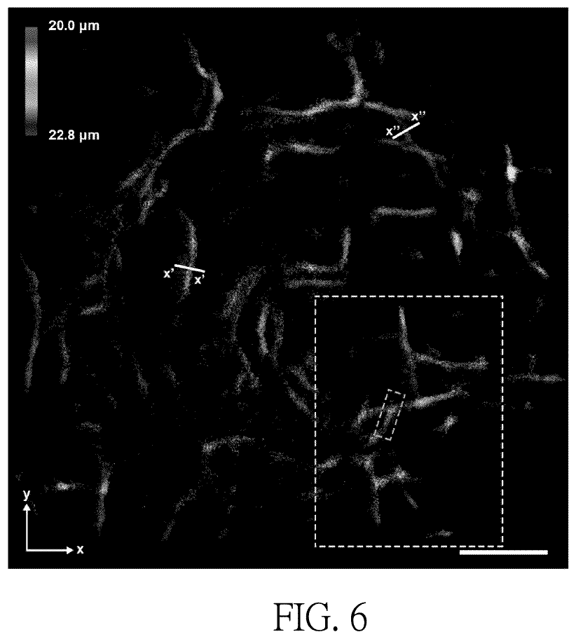

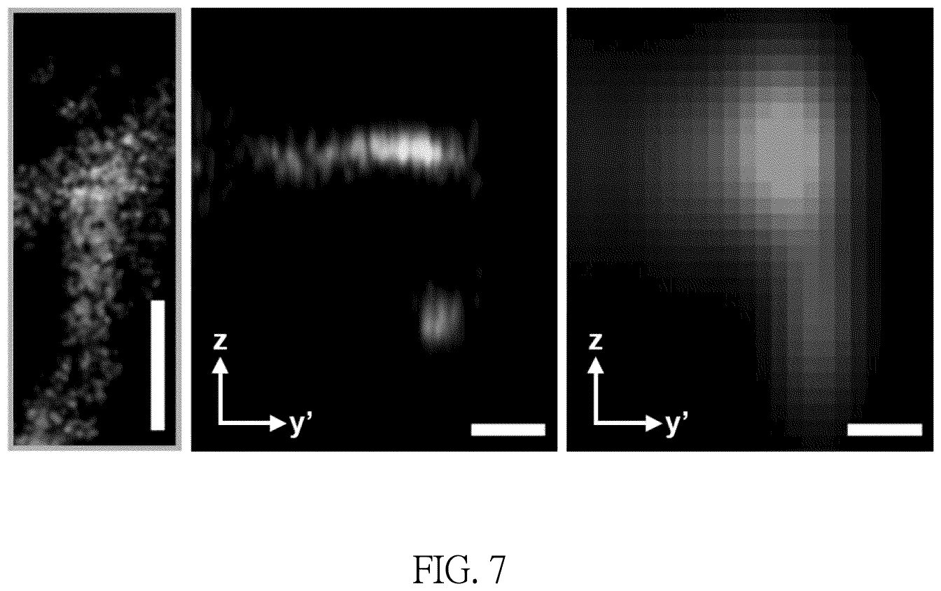

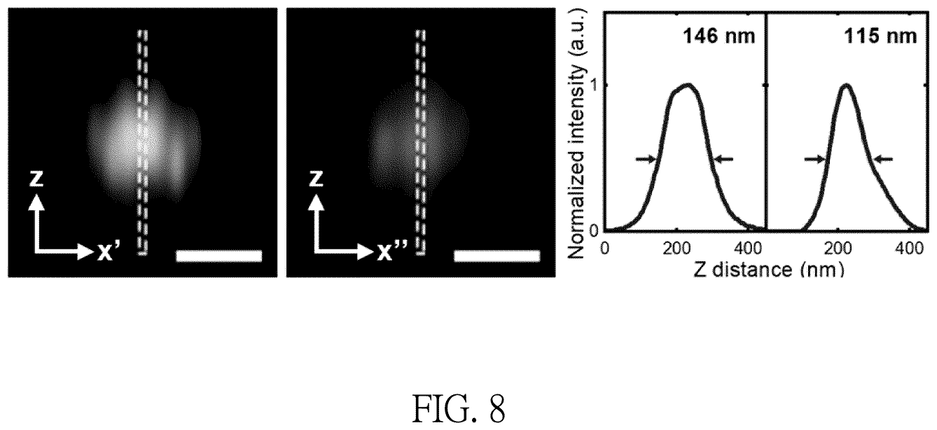

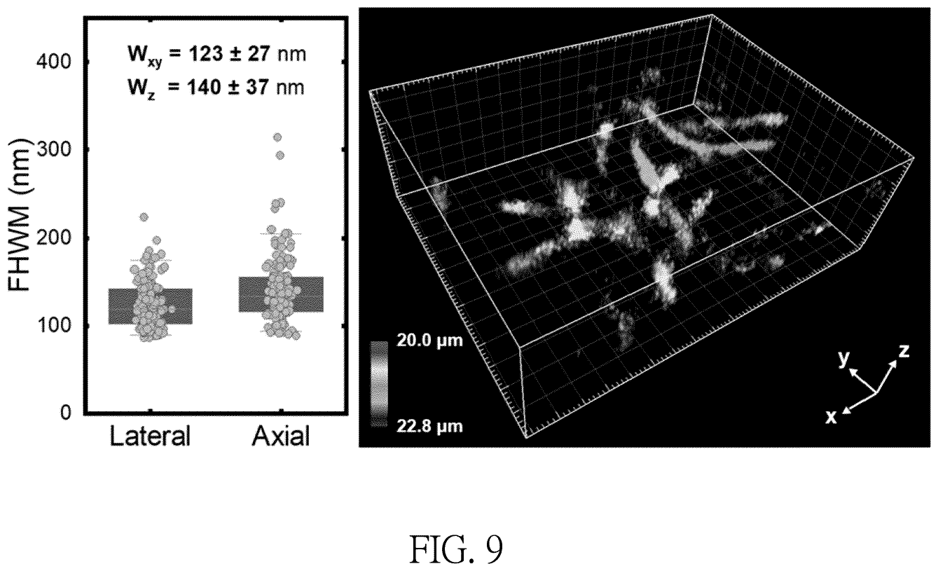

FIG. 3A shows the time trace of TPE fluorescence signals from a spontaneously blinking fluorescence molecule (e.g., hydroxyethyl tetra-trifluoroethyl rhodamine (HEtetTFER)) captured using the TFMPE system. The spontaneously blinking fluorescence mechanism molecule is not limited to HEtetTFER.

The time trace of TPE fluorescence signals from a fluorescence molecule with a photoswitchable fluorescence blinking mechanism (e.g., Atto 488) under temporal-focusing multiphoton excitation is shown in FIG. 3B.

In some embodiments of the present disclosure, the fluorescence molecule with a photoswitchable fluorescence blinking mechanism may be Atto 488, but the present disclosure is not limited thereto.

In some embodiments of the present disclosure, the fluorescent blinking molecules through the transient binding mechanism molecules may be, but not limited to, Nile Red and fluorescent nucleic acid molecule pair.

The time trace of TPE fluorescence signals from the transient binding mechanism molecules (e.g., Nile Red) under temporal-focusing multiphoton excitation is shown in FIG. 3C.

In some embodiments of the present disclosure, spontaneously blinking fluorophores have demonstrated the capability thereof during SMLM imaging to generate the spontaneously blinking fluorescence of a single fluorophore via an intramolecular spirocyclization reaction, in contrast to photoswitching dyes in direct stochastic optical reconstruction microscopy. For achieving the SMLM imaging, xanthene-based fluorophores and rhodamine-derivative fluorophores have been synthesized to exhibit the spontaneously blinking behaviors, which are through the mechanisms of the nucleophilic addition of intracellular glutathione and the intramolecular spirocyclization, respectively. Rhodamine derivatives are the most commonly used spontaneously blinking fluorophores. Because of the thermal equilibrium of their intramolecular spirocyclization reaction, they can switch between the fluorescent open form and the non-fluorescent spirocyclic form.

The present disclosure develops a TFMPE-SMLM system that utilizes single-wavelength excitation to achieve 3D SMLM imaging of spontaneously blinking fluorophores. TFMPE-SMLM offers wide-field and axially confined TPE and imaging by using the wide-field illumination of high peak-power and short-pulse-width laser pulses on an objective focal plane. This axial excitation confinement across the entire illumination area on the focal plane enables the optical-section fluorescence excitation of fluorophores labeled on cell and tissue specimens. The TFMPE-SMLM system substantially reduces the fluorescence background in out-of-focus regions and the photobleaching of out-of-plane fluorophores. In addition, fluorescence imaging by TPE enhances the imaging depth of specimens. The TFMPE-SMLM system also performs excitation wavelength scanning to determine the optimal excitation wavelength required to achieve high TPE efficiency of spontaneously blinking fluorophores.

To reconstruct SMLM images of microtubules in A549 cells, the present disclosure uses the developed TFMPE-SMLM system to capture TPE blinking fluorescence images of spontaneously blinking fluorophores. According to the Nyquist resolution and localization precision evaluations, an overall imaging resolution of 51 nm was achieved. In 3D SMLM imaging of thick biospecimens, axially confined TPE in the TFMPE-SMLM system reduces the photobleaching of out of-focus molecules to increase the utilization rate of the limited photon budget. In addition, a single-wavelength TFMPE-SMLM system without additional light activation has a simple system configuration without an additional objective lens or a specimen limit for a specific illumination direction. Consequently, the present disclosure uses the developed TFMPE-SMLM system to examine the morphology of cell mitochondria and the distribution of amyloid-beta (A3) proteins in brain tissues of a 5×FAD transgenic mouse with the pathological features of Alzheimer's disease (AD).

In at least one embodiment of the present disclosure, the ultrafast laser, the half-wave plate, the linear polarizer, the shutter, the first mirror, the scanning mirror, the diffraction grating, the collimating lens, the objective lens, the dichroic mirror, the short-pass emission filter, the imaging lens, the pair of cylindrical lenses, and the camera may be disposed in order along a direction of an optical path from the ultrafast laser to the camera.

In at least one embodiment of the present disclosure, the scanning module may further include a first lens and a second lens disposed between the scanning mirror and the diffraction grating, and the scanning mirror, the first lens, the second lens, and the diffraction grating may be disposed in order along a direction of the optical path from the ultrafast laser to the camera.

In at least one embodiment of the present disclosure, the system may further include a third lens, and a fourth lens. The diffraction grating, the third lens, the fourth lens, and the objective lens may be disposed in order along a direction of the optical path from the ultrafast laser to the camera.

In at least one embodiment of the present disclosure, the system may further include a first lens and a second lens disposed between the first mirror and the scanning mirror. The first lens may be used to adjust the incident light beam size, and the second lens may be used to reshape the incident light beam intensity distribution in the y-direction to obtain an uniform line beam, and the first mirror, the second lens, and the scanning mirror may be disposed in order along a direction of the optical path from the ultrafast laser to the camera.

In at least one embodiment of the present disclosure, the system may further include a first cylindrical lens and a second cylindrical lens disposed between the second lens and the scanning mirror and used to collimate the incident light beam in x- and y-direction. The second lens, the first cylindrical lens, the second cylindrical, and the scanning mirror may be disposed in order along a direction of the optical path from the ultrafast laser to the camera.

In at least one embodiment of the present disclosure, the scanning module may further include a third cylindrical lens disposed between the second cylindrical lens and the scanning mirror. The second cylindrical lens, the third cylindrical lens, and the scanning mirror may be disposed in order along a direction of the optical path from the ultrafast laser to the camera.

In at least one embodiment of the present disclosure, the scanning mirror may be a resonant-scanning mirror.

In at least one embodiment of the present disclosure, the scanning module may further include a parabolic concave mirror. The resonant-scanning mirror, the parabolic concave mirror, and the diffraction grating may be disposed in order along a direction of the optical path from the ultrafast laser to the camera.

In at least one embodiment of the present disclosure, the system may further include a bandpass emission filter disposed between the short-pass emission filter and the objective lens. The short-pass emission filter, the bandpass emission filter, and the objective lens may be disposed in order along a direction of the optical path from the ultrafast laser to the camera.

In at least one embodiment of the present disclosure, capturing the fluorescence image of the blinking fluorophore-labeled sample by the microscopy system may include detecting fluorescence switching between the blinking fluorescence signal of pattern fluorescence-on and fluorescence-off.

In at least one embodiment of the present disclosure, the blinking fluorophore may include the fluorophore with the blinking fluorescence signal generated by at least one approach selected from the group consisting of spontaneously blinking fluorescence, photoswitchable fluorescence, or transient binding.

In some embodiments of the present disclosure, the half-wave plate may be disposed between the ultrafast laser and the linear polarizer.

In some embodiments of the present disclosure, the linear polarizer may be disposed between the half-wave plate and the shutter.

In some embodiments of the present disclosure, the shutter may be disposed between the linear polarizer and the first mirror.

In some embodiments of the present disclosure, the shutter, the first mirror, and the scanning mirror may be disposed in order along a direction of the optical path from the ultrafast laser to the camera.

In some embodiments of the present disclosure, the first mirror, the scanning mirror, and the diffraction grating may be disposed in order along a direction of the optical path from the ultrafast laser to the camera.

In some embodiments of the present disclosure, the scanning mirror, the diffraction grating, and the collimating lens may be disposed in order along a direction of the optical path from the ultrafast laser to the camera.

In some embodiments of the present disclosure, the diffraction grating, the collimating lens, and the objective lens may be disposed in order along a direction of the optical path from the ultrafast laser to the camera.

In some embodiments of the present disclosure, the short-pass emission filter may be disposed between the dichroic mirror and the imaging lens.

In some embodiments of the present disclosure, the imaging lens may be disposed between the short-pass emission filter and the pair of cylindrical lenses.

In some embodiments of the present disclosure, the pair of cylindrical lenses may be disposed between the imaging lens and the camera.

### EXAMPLES

### Preparation of HEtetTFER Fluorophore and Fluorescence Nanosphere Specimens

To obtain clean glass coverslips, all coverslips are initially immersed in a 5% hydrochloric acid solution and cleaned by sonification for 0.5 h at room temperature, are then rinsed with deionized (DI) water and cleaned by sonification again in ethanol and DI water for 0.5 h at room temperature. A HEtetTFER fluorophore solution is prepared by diluting the initial solution into 1×10⁶ in DI water. A drop of the diluted solution is then placed on a glass coverslip and incubated for 1.5 h. After coating the HEtetTFER fluorophores on the glass coverslip, the blinking fluorescence thereof is measured using the TFMPE-SMLM system.

An agarose solution with a concentration of 0.3% (wt/vol) in 1×PBS is prepared by heating the agarose until it completely dissolved, and the solution is then cooled to approximately 60° C. Subsequently, the HEtetTFER fluorophores are diluted in this agarose solution at a concentration of 1 μM. The HEtetTFER-agarose solution is then poured into the cavity of a slide and mounted with a glass coverslip. The slide is maintained at 4° C. to solidify the agarose gel. This thick specimen of HEtetTFER-agarose gel is used to examine the effects of photobleaching on sequential axial images obtained by a wide-field single-photon excitation (SPE) fluorescence microscope and the TFMPE-SMLM system.

The glass coverslip is coated with poly-L-lysine at a concentration of 0.01% (wt/vol) for 0.5 h and then washed three times with DI water. A stock solution containing multiple fluorophore nanospheres with an average diameter of 140 nm is diluted to a concentration of 1×10⁵ (wt/vol) in DI water, and the diluted solution is added to the coated glass coverslip. After incubation for 1.5 h and washing three times with DI water, fluorescent nanospheres are attached to the surface of the glass coverslip. Subsequently, the glass coverslips are immersed in 1×PBS and glycerol solutions and used to measure axial excitation confinement.

### Mouse Brain Tissue Staining for TFMPE-SMLM Imaging

In accordance with the manufacturer's protocol, anti-mouse and anti-rabbit IgGs are conjugated with HEtetTFER fluorophores to prepare secondary antibodies for immunostaining. Briefly, anti-mouse and anti-rabbit IgGs are concentrated 10 times using an ultrafiltration filter (Vivaspin 500; Sartorius) and restored to the original volume with 0.1 M NaHCO₃ (pH 8.4) solution. HEtetTFER fluorophores in dimethyl sulfoxide solution are then added to the anti-mouse and anti-rabbit IgG solution at a molar ratio of 10:1 (HEtetTFER fluorophores to IgG protein). After the mixture is incubated at 4° C. overnight in the dark, it is transferred to a PD SpinTrap G-25 column (GE HealthCare) for the fractionation of secondary antibodies and unreacted HEtetTFER fluorophores. Finally, HEtetTFER-conjugated antibodies in PBS solution are collected for the subsequent immunostaining of mouse brain tissues.

5×FAD transgenic mice are purchased from the Jackson Laboratory (Bar Harbor, ME, USA). 5×FAD transgenic mice with amyloid-beta (Aβ) 42 accumulations and the amyloid pathological features of Alzheimer's disease (AD) are used to investigate the distribution of amyloid plaques in brain tissues. All animal experiments in this work are performed in accordance with National Institute of Health guidelines for the care and use of laboratory animals and approved by the Institutional Animal Care and Use Committee of National Central University (Approval Number: NCU-107-010). Each mouse is euthanized at the age of 6 months by CO2 inhalation. After mice are perfused with 30 mL of ice-cold 1×PBS, each mouse brain is rapidly removed and soaked in 1×PBS containing 4% paraformaldehyde for 24 h. The brain is then kept in a 30% sucrose solution at 4° C. until sinking to the bottom of the vial. Subsequently, the brain is orientationally embedded into a tissue-freezing medium (Leica). The frozen mouse brain is cut into 10-μm and 30-μm coronal sections on a cryostat microtome (CM3050S, Leica). Each section is soaked in 1×PBS containing 30% ethylene glycol, 30% sucrose, and 1% PVP-40 for cryoprotection and stored at −20° C. until staining. The sections are permeabilized with 0.1% Triton X-100 in 1×PBS, and their antigens are retrieved through soaking in 0.5% Tween 20 and 10 mM sodium citrate in 1×PBS at 95° C. for 10 min. Subsequently, the sections are blocked with 5% fetal bovine serum and 0.3% Triton X-100 in 1×PBS. After the sections are washed three times with 1×PBS containing 0.05% Tween 20, the Aβ proteins in the coronal sections are stained overnight with 3 μL mL-1 primary anti-Aβ antibodies and 20 μL mL-1 secondary antibodies conjugated with HEtetTFER at 4° C. for 12 h. Finally, the sections are washed three times with 1× PBS containing 0.05% Tween 20 for 10 min each and stored in 1×PBS for 3D TFMPE-SMLM imaging.

### TPE Spectrum Measurement System

In the two-photon excitation (TPE) spectrum measurement system, an ultrafast pulse laser is focused on the HEtetTFER solution in a cuvette, and the TPE fluorescence signals of HEtetTFER fluorophores are collected by an objective (10× PlanApo, Olympus). After being collected by an objective and filtered by a multiphoton dichroic mirror (FF670-SDi01-25×36, Semrock) and a short-pass filter (FF01-680/SP-25, Semrock), the TPE fluorescence signals are detected using a spectrometer (Shamrock SR-303i, Andor) combined with an electron-multiplying charge-coupled device (EMCCD) detector (iXon Ultra 897, Andor). TPE fluorescence spectra are obtained using this measurement system at different excitation wavelengths and powers.

### TFMPE-SMLM System Setup

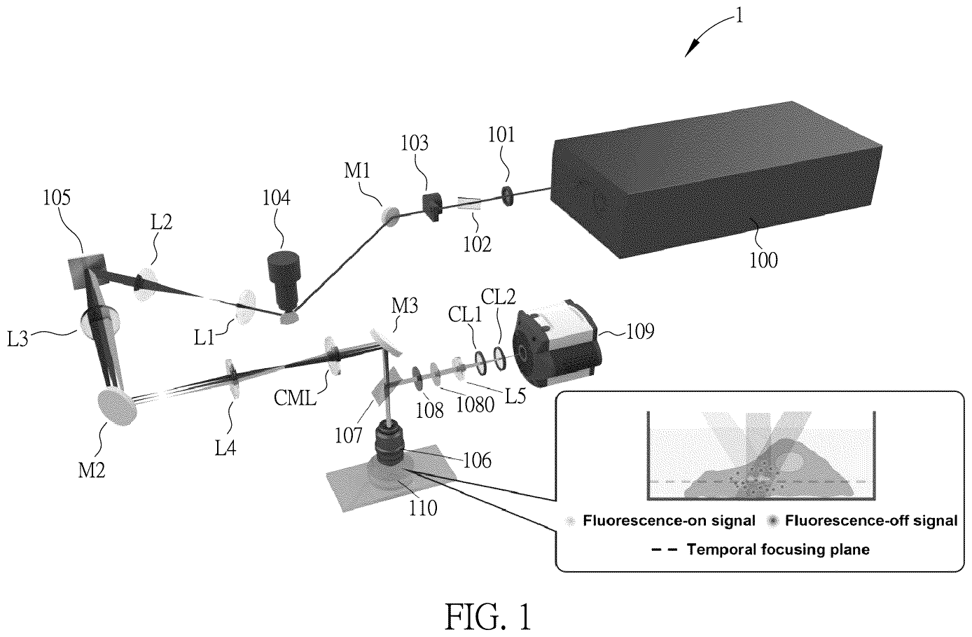

As shown in FIG. 1, a TFMPE-SMLM system 1 with a tunable excitation wavelength that is combined with astigmatic imaging is used to conduct TFMPE-SMLM imaging. A ultrafast pulse laser 100 (e.g., Ti:sapphire oscillator) (Chameleon version II, Coherent) with a pulse width of 140 fs, a repetition rate of 80 MHz, and a tunable wavelength of 680 nm to 1080 nm is used as the excitation laser for TPE fluorescence imaging. The ultrafast pulse laser 100 power is adjusted using a half-wave plate 101 (10RP52 2B, Newport) and a linear polarizer 102 (11B00UP.25, Newport). A shutter 103 and a first mirror M1 are used to control the illumination duration of the excitation laser and enable the excitation laser beam to illuminate the scanning mirror 104. A wavelength-selection module containing a scanning mirror 104 (GVS011, Thorlabs), a beam expander with a first lens L1 and a second lens L2 (#48-795, #86-918, Edmund optics), and a diffraction grating 105 (GR50-0608, Thorlabs) is used to increase the beam size of the ultrafast pulse laser 100 and adjust the illumination angle at the diffraction grating 105 depending on the central wavelength. Consequently, after being subjected to the diffraction grating 105, first-order diffraction light of different central wavelengths is maintained along the optical axis of the following optical path to achieve a tunable excitation wavelength range of 730 nm to 1000 nm in the TFMPE-SMLM system 1. The diffraction grating 105 induces spatial separation of the ultrafast pulse at different frequencies. After passing through the 4f configuration assembled using a collimating lens CML and a 1.2-NA water immersion objective lens 106 (60×UPLSAPO60XW, Olympus), all frequencies of the ultrafast pulse are recombined in phase on the objective focal plane, producing a short-width and high-peak-power pulse for achieving TPE over the entire illumination area of the objective focal plane. The illumination area generating TPE on the objective focal plane is approximately 50 μm×58 μm. The incident angle at the first lens L1 of the beam expander in the wavelength-selection module for excitation wavelengths 730 nm to 1000 nm based on the equation as previously described. The third lens L3 and a fourth lens L4 are used to perform the optical relay in the excitation optical path. After the objective lens 106 collected the TPE fluorescence signals resulting from the axial confinement excitation on the objective lens's focal plane, these signals are filtered using a multiphoton dichroic mirror 107 (FF705-Di01 25×36, Semrock), a short-pass emission filter 108 (FF01-720/SP-25, Semrock), and a bandpass emission filter 1080 (FF01 550/88-25, Semrock). Subsequently, the TPE fluorescence signals are imaged on the sensor plane of an EMCCD camera 109 (iXon Ultra 897, Andor) with a fifth lens L5 (e.g., an imaging lens) (f=200 mm, Thorlabs) and a pair of cylindrical lenses (i.e., a first cylindrical lens CL1 and a second cylindrical lens CL2) (Thorlabs) with focal lengths of 400 and −400 mm. These cylindrical lenses (i.e., a first cylindrical lens CL1 and a second cylindrical lens CL2) are used to induce an astigmatic effect to extract the axial positions of the fluorophores for the 3D SMLM images. Compared with the use of a single cylindrical lens, the use of a pair of cylindrical lenses offers advantages such as minimal shifting of the imaging plane for inducing an astigmatic effect, compensation of the orientation difference between the camera chip and the astigmatic point spread function (PSF), and elimination of the astigmatic effect through the fine-tuning of positive and negative cylindrical lenses for 2D SMLM imaging. A custom-built LabVIEW program is used to control an ultrafast pulse laser 100 to tune its central wavelength, a half-wave plate 101 to change the laser's 100 power, a scanning mirror 104 to adjust the illumination angle at the diffraction grating 105, a motorized focus stage 110 to modify the depth of each image, and an EMCCD camera 109 to capture fluorescence images. Specimens are positioned on the motorized focus stage 110 (PS3H122R, Prior Scientific) to acquire fluorescence signals at different imaging depths. Additionally, excitation wavelength-scanning TPE imaging is conducted by capturing a sequence of TPE fluorescent images at different excitation wavelengths.

### Line Scanning-TFMPE-SMLM System 1′ Setup

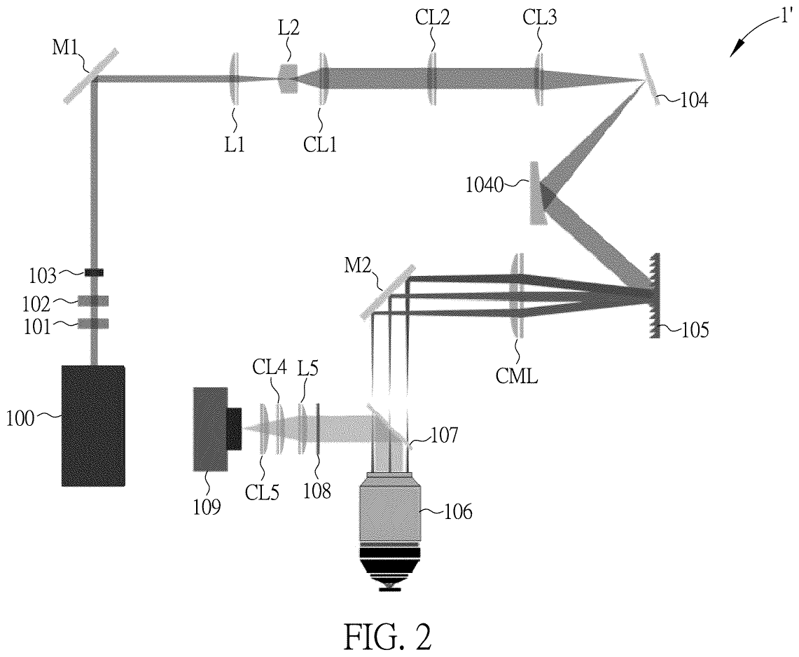

Referring to FIG. 2, a set-up of the line scanning-TFMPE-SMLM system 1′ is illustrated below. An ultrafast pulse laser 100 with a pulse width of 140 fs, a repetition rate of 80 MHz, and a tunable wavelength of 680 nm to 1080 nm is used as the excitation light for TPE fluorescence imaging. The laser power is adjusted using a half-wave plate 101 and a linear polarizer 102. A shutter 103 and a first mirror M1 are used to control the illumination duration of the excitation laser and enable the excitation laser beam to normal incident at the first lens L1. A first lens L1 (e.g., a focusing lens) is used to adjust the laser beam to an appropriate size for incident along a second lens L2 (e.g., a Powell lens). The second lens L2 (e.g., a Powell lens) will fan and reshape the beam intensity distribution in the y-direction to obtain a uniform line beam. Consequently, after the beam is fanned out by the second lens L2 (e.g., a Powell lens), two cylindrical lenses (i.e., a first cylindrical lens CL1 and a second cylindrical lens CL2) are used to collimate the beam in an orthogonal direction (x- and y-direction) to obtain the appropriate beam shape. Then, a resonant-scanning module containing a third cylindrical lens CL3, a resonant-scanning mirror 104, and a parabolic concave mirror 1040 is used to adjust the beam size of the ultrafast pulse laser 100 and scanned the line beam along a diffraction grating 105. Concurrently, the beam's incident angle towards the diffraction grating 105 will be adjusted to an appropriate angle that allows the first-order diffracted beam to be directed along the optical axis of the following optical path in the line scanning temporal-focusing multiphoton excitation (LsTFMPE) system. The diffraction grating 105 induces spatial separation of the ultrafast pulse at different frequencies. After passing through the 4f configuration assembled using a collimating lens CML and an objective lens 106, all frequencies of the ultrafast pulse are recombined in phase on the objective focal plane, producing a short-width and high-peak-power pulse for achieving TPE at the objective focal plane. As the diffraction grating 105 and the objective focal plane are conjugated, the beam that scanned along on the diffraction grating 105 will also be scanned onwards the objective focal plane. After the objective lens 106 collects the TPE fluorescence signals resulting from the axial confinement excitation on the objective focal plane, these signals are filtered using a multiphoton dichroic mirror 107 and a short-pass emission filter 108. Subsequently, these signals are imaged on the sensor plane of a camera 109 with a fifth lens L5 (e.g., an imaging lens).

TPE Spectral Measurement Using the TFMPE-SMLM System with Excitation Wavelength Scanning

At the optimal excitation wavelength of HEtetTFER fluorophores for achieving high TPE efficiency, a large number of photons are produced from a single localization event. Given that the TFMPE-SMLM system may achieve tunable excitation wavelengths, this system is used to investigate the optimal excitation wavelengths of fluorophores. Accordingly, TPE fluorescence images of the tubulin of A549 cells immunostained with HEtetTFER fluorophores are acquired at excitation wavelengths from 760 nm to 920 nm with a wavelength increment of 20 nm and a power density of 20.2 kW/cm².

### TPE Blinking Fluorescence Measurement of a Single HEtetTFER Fluorophore at Various pH Values and Excitation Power Densities

To quantitatively investigate the pH-dependent behavior of HEtetTFER blinking fluorescence caused by the TPE mechanism, time-lapse TPE fluorescence images of HEtetTFER fluorophores coated on a glass coverslip are acquired using the TFMPE-SMLM system at pH values ranging from 5.0 to 9.0 with an increment of 0.5. This imaging is performed at an excitation power density of 52.2 kW/cm², with a total detection time of 250 s and a temporal resolution of 67 ms. After bandpass image filtering is conducted in the frequency domain to suppress pixel noise, the local maxima method, with an intensity threshold of 120 a.u., is used to extract the locations of all fluorescence spots in each image in the TPE fluorescence image stack. Based on the locations of the fluorescence spots in all images, the nearest neighbor algorithm is used to sort out the fluorescence spots from the same emitter. Subsequently, in all raw images of each TPE fluorescence image stack, the fluorescence intensities of an emitter within a window of 7×7 pixels are subtracted from the background value, which is determined using the average value of the peripheral pixels of each cropped window, and summed to obtain the fluorescence time trace of a HEtetTFER fluorophore. To evaluate the blinking properties of HEtetTFER fluorophores at different pH values, the time trace of the fluorescence signals of HEtetTFER fluorophores is used to calculate the TPE fluorescence intensity and the number of blinking events.

Additionally, the number of blinking events in HEtetTFER and various commercially available photoswitching dyes used in TFMPE-SMLM imaging is also compared. Commercially available photoswitching dyes (Cy5 and xanthene derivatives Alexa Fluor 568 and ATTO 488), which are commonly used in direct stochastic optical reconstruction microscopy in the presence of an oxygen scavenger and a redox buffer (e.g., βME solution) are used. To prepare the oxygen scavenger and the redox buffer, 14.3 M βME solution is diluted with a 50 mM Tris solution containing 10 mM sodium chloride and 10% glucose to concentrations of 100, 200, and 500 mM. Subsequently, 1% GLOX solution containing 56 mg/mL glucose oxidase, 3.4 mg/mL catalase, and 50 mM sodium chloride in 10 mM Tris solution is added to each βME solution. Cy5, Alexa Fluor 568, and ATTO 488 fluorophores coated on glass coverslips are fabricated using the same method as for HEtetTFER fluorophores. Subsequently, the time traces of TPE fluorescence signals of Cy5, Alexa Fluor 568, and ATTO 488 are acquired using the TFMPE-SMLM system at their optimal TPE wavelengths (i.e., 790 nm for Cy5 and Alexa Fluor 568 and 780 nm for ATTO 488). To compare the blinking events of Cy5, Alexa Fluor 568, and ATTO 488, the excitation power densities and βME concentrations are varied to determine the optimal number of blinking events in TFMPE-SMLM imaging.

### Calibration Curves for Axial Localization Through an Astigmatism-Based Approach

Before 3D TFMPE-SMLM imaging is conducted, a 140-nm fluorescent nanosphere is used as a single emitter. It is imaged at every z position with a step shift of 40 nm across a range of 2 μm to record the astigmatic PSF variation patterns. These patterns are then used to estimate the elliptical widths in the x and y directions with an elliptical Gaussian function and a least-squares fitting method. Subsequently, the estimated results are refined using a maximum-likelihood estimator fitting method to reconstruct calibration curves in two directions through a defocusing model. To achieve a higher axial resolution in 3D TFMPE-SMLM images, the axial position of each blinking fluorophore is extracted using calibration curves in accordance with the imaging pattern variations in the astigmatic images.

### Fluorescence Images of Aβ Deposits in an AD Mouse Brain Through Conventional SPE Fluorescence Microscopy

After Aβ proteins in the brain coronal sections of 5×FAD transgenic mice with AD are immunostained with Alexa Fluor 568, Aβ deposits are visualized under a wide-field SPE fluorescence microscope (Axio Observer, Carl Zeiss) at different magnifications. As shown in FIG. 5, Three objectives (10×UPLSAPO10X, 20×LUCPLFLN20X, 60×UPLSAPO60XW, Olympus) are used to detect the dense distribution of Aβ deposits and the morphology of each Aβ deposit.

### 3D TFMPE-SMLM Imaging

For 3D TFMPE-SMLM imaging, an astigmatism-based approach based on a pair of cylindrical lenses in an imaging path is applied to determine the axial location of each blinking event. To obtain 3D TFMPE-SMLM images of mouse brain tissues, Aβ labeled with HEtetTFER is sequentially and axially imaged with a step size of 0.4 μm at the same excitation-power density as that used for 2D TFMPE-SMLM imaging. More than 600 frames of blinking fluorescence images captured at each specimen depth are used to calculate a layered 3D TFMPE-SMLM image. Subsequently, 3denseSTORM is used to obtain the 3D localization information of each blinking fluorophore through fitting with an elliptical Gaussian function and resolving with a defocusing model based on calibration curves. By using a normalized Gaussian function and magnification of 20×, ThunderSTORM is applied to reconstruct the 3D localization information into z-slice TFMPE-SMLM images with a slice thickness of 5 nm. To perform 3D TFMPE-SMLM imaging of cell mitochondria, 8000 frames of blinking fluorescence images under an astigmatic effect are captured to reconstruct a 3D TFMPE-SMLM image. Thus, sequential 3D TFMPE-SMLM images are rendered into 3D image stacks and replotted as 2D images with color coding indicating z positions, revealing the distribution and morphology of mitochondria in A549 cells and of Aβ aggregates in the brain tissues of mice with AD.

### Resolution Evaluation of 2D/3D TFMPE-SMLM Images

Localization precision, Nyquist resolution, and Fourier ring correlation (FRC)/Fourier shell correlation (FSC) are used to evaluate the resolution of 2D/3D TFMPE-SMLM images obtained using the TFMPE-SMLM system. The localization precision of each TFMPE-SMLM image is determined by investigating the photon counting noise, pixelation noise, and background noise of each localization event, as previously described. Additionally, according to the Nyquist-Shannon sampling criterion, an increased localization density plays a crucial role in enhancing the resolution of TFMPE-SMLM images. Therefore, the area of the structure of interest in each 2D TFMPE-SMLM image is estimated using an intensity threshold for determining the localization density, and the Nyquist resolution is calculated using the formula R_{Nyquist}=2/(localization density)^{1/.2}. Given the simultaneous effects of localization precision and density, FRC analysis is conducted as an alternative approach to evaluate the spatial resolution of each 2D TFMPE-SMLM image. To identify the finest distinguishable features in each 2D TFMPE-SMLM image, the FRC correlation between the Fourier transforms of two independent reconstructions divided by the raw blinking image stack of the same imaging region is calculated. The spatial frequency of correlations is set below a defined threshold of 1/7, which is optimal for defining the FRC resolution of 2D TFMPE-SMLM images. For 3D TFMPE-SMLM imaging, FSC analysis is conducted to evaluate image resolution. Generally, FSC is calculated similarly to how FRC is calculated, but the image data used for FSC calculation are extended to 3D. A 3D TFMPE-SMLM data set is divided into two blinking image subsets to obtain two independent reconstructions. These reconstructions are then used to estimate the FSC value as follows:

$$FSC ( r ) = \frac{Σ G 1 ( r ) G {2}^{*} ( r )}{\sqrt{Σ {\vert G 1 ( r ) \vert}^{2} Σ {\vert G 2 ( r ) \vert}^{2}}} ,$$

where G1 and G2 denote 3D reconstruction images in the frequency domain, and r is a spatial frequency vector. Notably, the FSC resolution of each 3D TFMPE-SMLM image is regarded as a spatial frequency at an FSC value of just below 1/7, similar to FRC analysis.

### Results

### TPE Spectral Measurement of Spontaneously Blinking Fluorophores

Hydroxyethyl tetra-trifluoroethyl rhodamine (HEtetTFER) fluorophore is a commercially available, spontaneously blinking fluorophore that is first published by Uno et al. HEtetTFER fluorophores blink spontaneously as a result of switching between a fluorescent open form and a non-fluorescent spirocyclic form in an intramolecular spirocyclization reaction. Although HEtetTFER fluorophores have been used for SPE-SMLM imaging, their photophysical properties under the TPE remain to be examined. To explore the two-photon photophysical properties of HEtetTFER fluorophores, the measurement system of TPE spectra is used to investigate the optimal TPE wave length of HEtetTFER. The TPE fluorescence spectra of HEtetTFER at excitation wavelengths ranges from 730 nm to 960 nm. A comparison of the two-photon absorption cross section of HEtetTFER reveals that an excitation wavelength of 840 nm produces the maximum TPE fluorescence intensity. To confirm the excitation of the HEtetTFER fluorescence signals through the TPE mechanism, the excitation-power dependence of HEtetTFER fluorescence intensity at an excitation wavelength of 840 nm is investigated. Generally, the TPE fluorescence intensity is characterized by power-squared dependence. The integrated intensities of the fluorescence spectra are fitted to a linear curve with a slope of 2.01. The fitting result indicates that the excitation of the HEtetTFER fluorescence signals at the wavelength of 840 nm is induced by the TPE mechanism. In addition, the TPE spectrum of HEtetTFER is also obtained using the TFMPE-SMLM system with an excitation wavelength scanning at a wavelength increment of 20 nm across an excitation wavelength range of 760 to 920 nm. The TFMPE-SMLM system with a tunable excitation wavelength allows wide field and axially confined TPE across the specimens to obtain the TPE fluorescence images. According to the TPE fluorescence image results of the tubulin of A549 cells immunostained with HEtetTFER fluorophores, the TPE fluorescence image captures at an excitation wavelength of 840 nm exhibited microtubular structures and has a higher intensity compared with images captured at other excitation wavelengths. The TPE spectrum of HEtetTFER is obtained by evaluating the intensity of each TPE fluorescence image. At an excitation wavelength of 840 nm, the TPE fluorescence of HEtetTFER exhibits the maximum intensity. Therefore, the excitation wavelength is fixed in all subsequent measurements at about 840 nm for HEtetTFER imaging.

### TPE Blinking Fluorescence Measurement of Single Fluorophore

Fluorescence blinking is an essential property of fluorophores in SMLM imaging. The spontaneous fluorescence blinking of HEtetTFER induced by the intramolecular spirocyclization reaction is investigated using the TFMPE-SMLM system. FIG. 3A shows the time trace of the TPE fluorescence intensity from a single HEtetTFER fluorophore coated on a glass coverslip at pH 7.0 over a detection duration of 250 s. Stochastic fluorescence blinking of HEtetTFER occurs through the thermal equilibrium of the intramolecular spirocyclization reaction, which induces the switching between a fluorescent open form and a non-fluorescent spirocyclic form. Consequently, HEtetTFER demonstrates spontaneous switching between the signals of fluorescence-on and fluorescence-off, as depicted by TPE fluorescence images (inset in FIG. 3A). To estimate the fluorescence intensity and blinking events of HEtetTFER, the TPE fluorescence signals of HEtetTFER are detected at an intensity threshold of Iₜₕ=I_{avg}+3I_{std}, where I_{avg} and I_{std} are the average and standard deviation of the background intensity, respectively. Signals exceeding the threshold are regarded as indicative of TPE fluorescence of HEtetTFER and are used to obtain the histograms of blinking intensity and determine the number of blinking events. The average TPE fluorescence blinking intensity and the average number of blinking events from a single HEtetTFER fluorophore are 722 a.u. and 43 counts, respectively. The lifetime of the fluorescent open form of a single HEtetTFER fluorophore is also measured by using TFMPE-SMLM system at an exposure time of 20 ms. The average lifetime value is 72 ms. This fluorescent open form exhibits a duty cycle of 0.074. In addition, the localization precision of HEtetTFER in TFMPE-SMLM imaging at various exposure times is compared and the localization precision converged to approximately 20 nm when the exposure time exceeded 50 ms is discovered. Therefore, the exposure time used in two-dimensional (2D)/3D TFMPE-SMLM imaging is about 50 ms. The exposure time is capable of providing sufficient localization precision for capturing TFMPE-SMLM images of HEtetTFER fluorophores. Additionally, because the kinetics of intramolecular spirocyclization for HEtetTFER strongly correlates with the pH of the measurement environment, TPE fluorescence blinking is examined at pH 5.0 to pH 9.0 with a pH increment of 0.5. The TPE fluorescence time traces of a single HEtetTFER fluorophore are evaluated over a detection duration of 250 s. The TPE blinking fluorescence intensity of a blinking event for a single HEtetTFER fluorophore exhibits a small increment in acidic environments, which may be due to the extended lifetime of the fluorescent open form of HEtetTFER at low pH values. In addition, because HEtetTFER is more likely to exist in an open form in an almost acidic environment, the blinking events of HEtetTFER slightly decrease when the pH value increases. However, according to the SPE result, the HEtetTFER fluorophores in the acidic environment have a high population in a fluorescent open form. Nonetheless, this increase in the HEtetTFER fluorophore existing in the fluorescent open form does not lead to a significant increase in the number of blinking events measured by TPE, presumably because of the high power density of excitation light used in TFMPE. This high-power density of excitation light presumably increases the fluorophore photobleaching and the fluorophores entering the off state. When the excitation power density is reduced, the number of blinking events from a single HEtetTFER fluorophore at pH 5.0 increases. This result indicates that the blinking events of HEtetTFER are both dominated by the thermal equilibrium of intramolecular spirocyclization and affected by the excitation power density. However, at a physiological pH value of 7.4, blinking events do not considerably decrease as compared with the results observed in the acidic environment. Therefore, the TFMPE-SMLM system may be used to acquire TPE fluorescence blinking with a sufficiently large number of photons for performing SMLM imaging at a physiological pH value of about 7.4.

The developed TFMPE-SMLM system to examine the blinking events of different types of fluorophores and determine the suitability of other fluorophores for TFMPE-SMLM imaging is also used. Other types of fluorophores, such as Cy5 and xanthene derivatives (e.g., Alexa Fluor 568 and ATTO 488) are used. In some embodiments of the present disclosure, Cy5, Alexa Fluor 568, and ATTO 488 are commonly used as photoswitching dyes in dSTORM imaging. The blinking events of Cy5, Alexa Fluor 568, and ATTO 488 by varying the excitation power densities and βME concentrations are compared to identify the optimal number of blinking events in TFMPE-SMLM imaging. Because the overall imaging resolution of SMLM imaging depends on both localization precision and density, these analysis results of the localization precision and the number of blinking events indicate that HEtetTFER fluorophores used for TFMPE-SMLM may provide the most significant number of blinking events to ensure high localization density and sufficient photons to maintain acceptable localization precision. Additionally, TFMPE-SMLM using HEtetTFER fluorophores may achieve single-wavelength excitation SMLM imaging and does not require a specialized imaging buffer. Accordingly, the HEtetTFER fluorophores are used to perform TFMPE-SMLM imaging.

### Axial Excitation Confinement for 3D Fluorescence Imaging

The TFMPE approach provides the significant advantage of axial excitation confinement for the entire illumination area on the focal plane. The axial excitation confinement of the TFMPE-SMLM system is estimated through the Fourier transform calculation. The upper left panel and the lower left panel of FIG. 4 show the measured and simulated spectral distributions of the ultrafast laser beam at the back focal plane of the 1.2-NA water immersion objective (60×UPLSAPO60XW, Olympus) in the TFMPE-SMLM system with a central wavelength of about 840 nm, a bandwidth of about 6.8 nm, a sech 2-shaped pulse, a grating groove density of about 600 lines/mm, and a collimating lens focal length of about 600 mm. The spectrum band of the ultrafast laser beam exhibits a line distribution, which is similar to the pulse spectrum band obtained using a conventional TFMPE microscope. At the back focal plane of the objective, the spectrum size of the ultrafast laser beam is similar to the diameter of the back aperture of the objective, thus providing more suitable axial excitation confinement for optical-section imaging. In biospecimens, axial excitation confinement may vary because of the specimens' nonhomogeneous compositions. The nonhomogeneous compositions of specimens are considered to induce variations in their effective refractive indexes. The mouse brain tissue slice exhibits a refractive index range of 1.34 to 1.41 in different regions. Although axial excitation confinement increased when the specimen refractive index increased, axial excitation confinement exhibits only a small variation of approximately 0.38 μm for the refractive index range of 1.34 to 1.41. To examine the range of axial excitation confinement for the TFMPE-SMLM system, axial-section fluorescence images are acquired for fluorescent nanospheres coated on a coverslip in 1×PBS and glycerol solutions at different axial positions with an increment of 50 nm across an axial range of 20 μm. As shown in the upper middle panel of FIG. 4, the axial intensity profiles of a fluorescent nanosphere are obtained by integrating the intensity of each section image. Each normalized intensity profile is then fitted using a spatially chirped beam fitting equation to estimate the FWHM, which is regarded as the axial excitation confinement. The axial excitation confinements of the TFMPE-SMLM system for fluorescent nanospheres in PBS and glycerol solutions are approximately 2.8±0.1 and 3.4±0.1 μm, respectively. At refractive indices of approximately 1.334 and 1.468 for PBS and glycerol, respectively, the axial excitation confinements of the TFMPE-SMLM system are similar to the simulation results in the lower middle panel of FIG. 4. Therefore, with the axially confined excitation of the TFMPE-SMLM system, optical-section TFMPE imaging of mouse brain vasculatures may be acquired to reveal their 3D morphology. During sequential axial imaging performs to render a 3D SMLM image, a wide-field axially confined TPE approach may be used to reduce the fluorescence photo bleaching effect of blinking fluorophores not located in the region of axial excitation confinement. The upper right panel of FIG. 4 illustrates the differences in fluorescence photobleaching between the SPE and TFMPE approaches in sequential axial imaging. SPE and TFMPE fluorescence images of HEtetTFER agarose gel specimens are captured at different depths at increments of 1 μm over a range of 25 m. To simulate 3D SMLM imaging, the excitation duration at each imaging depth is set to 60 s. The power densities for the SPE and TFMPE approaches are 1.43 and 6.28 kWcm⁻², respectively. When the imaging depth increases, the fluorescence intensities for SPE rapidly decrease. At an imaging depth of 5 μm, the fluorescence intensity remains below 19%. The fluorescence intensity measured at each depth results from the first illumination of 473-nm excitation light. Although the fluorescence intensity slightly decreases at a penetration depth of 25 μm, it remains at 82% of its original value. This result indicates that the reduction observed in the fluorescence intensities of the HEtetTFER-agarose gel specimen in sequential axial imaging through SPE in the upper right panel of FIG. 4 is only partially influenced by the penetration depth of the specimen but dominated by a fluorescence photo bleaching effect. Although the power density of TFMPE is 4.4 times more than that of SPE, the fluorescence intensities at imaging depths of 0 to 25 μm remain higher than 90% of that at the initial depth (the upper right panel of FIG. 4). Therefore, TFMPE may aid in avoiding the excitation of blinking fluorophores at other depths for specimens, not in the recording depth range to reduce the total number of localization molecules of a 3D SMLM image due to the photobleaching effect as shown in the lower right panel of FIG. 4. TFMPE effectively utilizes the photon budget of localization molecules in thick specimens for achieving 3D SMLM imaging.

### 3D TFMPE-SMLM Imaging of Pathological Aggregates of AD in Mouse Brain Tissue

To explore the morphology of Aβ peptide deposits in the brain, the developed 3D TFMPE-SMLM system is used to visualize the distribution of Aβ peptides in the brain tissues of 5×FAD transgenic mice. In some embodiments of the present disclosure, Aβ peptide deposits forming amyloid plaques in the brain are regarded as pathological hallmarks of AD. Neurotoxic Aβ peptides originate from the sequential proteolysis of amyloid precursor proteins (APPs). Through the cleavage of β-secretase and γ secretase, APPs induce the accumulation of Aβ for the formation of amyloid oligomers, protofibrils, fibrils, and plaques. Numerous Aβ peptide deposits are detected in the cortex, subiculum, and hippocampus of the 5×FAD transgenic mice. The Aβ peptides in the cortex are immunostained with Alexa Fluor 568 and imaged using conventional SPE wide-field fluorescence microscopy (FIG. 5) to compare the image resolution of this technique to that of 3D TFMPE-SMLM imaging. Although many large deposits of Aβ peptides are discovered in the brain section, their morphology is indistinct. FIG. 6 provides the 3D TFMPE-SMLM images of Aβ peptide deposits that are captured using the 3D TFMPE-SMLM system and reconstructed using the aforementioned procedure in 3D TFMPE-SMLM imaging. 3D TFMPE-SMLM imaging revealed the fibril bundle structures of Aβ peptides in the brains of 5×FAD transgenic mice. The left panel of FIG. 7 depicts the proximity of Aβ fibril bundles (orange dashed box in FIG. 6), with an axial spacing of approximately 1074 nm (the middle panel of FIG. 7), which cannot be obviously resolved in the conventional 3D TFMPE fluorescence image shown in the right panel of FIG. 7. According to the axial cross-sectional images of two Aβ fibril bundles (the left panel, the middle panel, and the right panel of FIG. 8), the FWHM of the intensity profile is regarded as the widths of the two Aβ fibril bundles, which are 115 and 146 nm, respectively. Further evaluation of these Aβ fibril bundles revealed that their lateral and axial mean widths are approximately 123±27 and 140±37 nm (the left panel of FIG. 9). The right panel of FIG. 9 shows the 3D-rendered image from the z stack of the region enclosed by the white dashed box in FIG. 6. Therefore, the TFMPE system offers optical sectioning capabilities, a sufficient frame rate, and nominal photobleaching, enabling the 3D SMLM imaging of brain tissue sections. In addition, the maximum imaging depth achieved by the TFMPE-SMLM system in these opaque specimens of mouse brain tissue was found to be about 24 μm. This maximum imaging depth of TFMPE-SMLM is influenced by the low fluorescence intensity of HEtetTFER fluorophores and the nonhomogeneous composition of mouse brain tissue.

Combining SMLM with TFMPE for spontaneously blinking fluorophores provides nanoscale-level 3D imaging of mouse brain tissues with improved fluorophore photobleaching in the axial direction through axial excitation confinement and single-wavelength excitation. TFMPE-SMLM may provide high temporal resolution in TPE fluorescence imaging by generating axially resolved plane-by-plane excitations and capturing a TPE image of the entire excitation area with a high-speed camera to record the rapid TPE fluorescence blinking signals of fluorophores. To increase the number of detected photons from HEtetTFER for single-molecule localization, the optimal excitation wavelength for obtaining the high TPE efficiency of HEtetTFER is determined through excitation wavelength-scanning measurement. Consequently, the blinking TPE fluorescence of HEtetTFER is obtained through TFMPE imaging at an excitation wavelength of about 840 nm. Furthermore, in the TFMPE-SMLM system, an astigmatism-based approach is utilized to determine the individual axial positions of blinking fluorophores for 3D SMLM imaging. The 3D TFMPE-SMLM system reveals the morphology of neurotoxic Aβ peptide deposits in the brain tissues of 5×FAD transgenic mice with AD. Thus, the 3D TFMPE-SMLM system has great potential for exploring the distribution of molecules and subcellular structures in biotissue specimens at a super-resolution level.

Those skilled in the art will readily observe that numerous modifications and alterations of the system and method may be made while retaining the teachings of the disclosure. Accordingly, the above disclosure should be construed as limited only by the metes and bounds of the appended claims.

What is claimed is:

1. A microscopy system, comprising:
an ultrafast laser for emitting incident light beam;
a half-wave plate coupled to the ultrafast laser and configured to adjust power of the ultrafast laser;
a linear polarizer coupled to the half-wave plate and configured to adjust the power of the ultrafast laser;
a shutter coupled to the linear polarizer;
a first mirror coupled to the shutter;
a scanning module coupled to the first mirror, comprising:
a scanning mirror; and
a diffraction grating coupled to the scanning mirror for generating a diffraction light beam, wherein the scanning module is configured to adjust the incident light beam size of the ultrafast laser and the incident light beam angle;
a collimating lens coupled to the scanning module and configured to form a 4f configuration with an objective lens;
the objective lens coupled to the collimating lens for focusing and recombining the diffraction light beam to excite a blinking fluorescence signal of a sample and collecting the blinking fluorescence signal of the sample, wherein the sample comprises a fluorophore;
a dichroic mirror coupled to the objective lens and configured to filter the fluorescence signal;
a short-pass emission filter coupled to the dichroic mirror and configured to filter the fluorescence signal;
an imaging lens coupled to the short-pass emission filter and configured to allow the fluorescence signal being imaged;
a pair of cylindrical lenses coupled to the imaging lens and configured to induce an astigmatic effect to extract an axial position of the fluorophore; and a camera coupled to the pair of cylindrical lenses and configured to capture a blinking fluorescence image.

2. The microscopy system of claim 1, wherein the ultrafast laser, the half-wave plate, the linear polarizer, the shutter, the first mirror, the scanning mirror, the diffraction grating, the collimating lens, the objective lens, the dichroic mirror, the short-pass emission filter, the imaging lens, the pair of cylindrical lenses, and the camera are disposed in order along a direction of an optical path from the ultrafast laser to the camera.

3. The microscopy system of claim 1, further comprising:
a first lens and a second lens disposed between the first mirror and the scanning mirror; and
wherein:
the first lens is configured to adjust the incident light beam size;
the second lens is configured to reshape the incident light beam intensity distribution in the y-direction to obtain an uniform line beam; and
the first mirror, the second lens, and the scanning mirror are disposed in order along a direction of the optical path from the ultrafast laser to the camera.

4. The microscopy system of claim 1, further comprising a first cylindrical lens and a second cylindrical lens disposed between the second lens and the scanning mirror and configured to collimate the incident light beam in x- and y-direction, wherein:
the second lens, the first cylindrical lens, the second cylindrical, and the scanning mirror are disposed in order along a direction of the optical path from the ultrafast laser to the camera;
the scanning module further comprises a third cylindrical lens disposed between the second cylindrical lens and the scanning mirror; and
the second cylindrical lens, the third cylindrical lens, and the scanning mirror are disposed in order along a direction of the optical path from the ultrafast laser to the camera.

5. The microscopy system of claim 1, wherein:
the scanning mirror is a resonant-scanning mirror;
the scanning module further comprises a parabolic concave mirror; and
the resonant-scanning mirror, the parabolic concave mirror, and the diffraction grating are disposed in order along a direction of the optical path from the ultrafast laser to the camera.

6. A method for constructing a single-molecule fluorescence image, comprising:
capturing the fluorescence image of a blinking fluorophore-labeled sample by a microscopy system, wherein the fluorescence image is a blinking fluorescence image, and the microscopy system comprises:
an ultrafast laser for emitting incident light beam;
a half-wave plate coupled to the ultrafast laser and configured to adjust power of the ultrafast laser;
a linear polarizer coupled to the half-wave plate and configured to adjust the power of the ultrafast laser;
a shutter coupled to the linear polarizer;
a first mirror coupled to the shutter;
a scanning module coupled to the first mirror, comprising:
a scanning mirror; and
a diffraction grating coupled to the scanning mirror for generating a diffraction light beam, wherein the scanning module is configured to adjust the incident light beam size of the laser and the incident light beam angle;
a collimating lens coupled to the scanning module and configured to form a 4f configuration with an objective lens;
the objective lens coupled to the collimating lens for focusing and recombining the diffraction light beam to excite a blinking fluorescence signal of the blinking fluorophore-labeled sample and collecting the blinking fluorescence signal of the blinking fluorophore-labeled sample;
a dichroic mirror coupled to the objective lens and configured to filter the blinking fluorescence signal;
a short-pass emission filter coupled to the dichroic mirror and configured to filter the blinking fluorescence signal;
an imaging lens coupled to the short-pass emission filter and configured to allow the blinking fluorescence signal being imaged;
a pair of cylindrical lenses coupled to the imaging lens and configured to induce an astigmatic effect to extract an axial position of a fluorophore; and
a camera coupled to the pair of cylindrical lenses and configured to capture the blinking fluorescence image; and
constructing the single-molecule fluorescence image of the blinking fluorophore-labeled sample.

7. The method of claim 6, wherein the ultrafast laser, the half-wave plate, the linear polarizer, the shutter, the first mirror, the scanning mirror, the diffraction grating, the collimating lens, the objective lens, the dichroic mirror, the short-pass emission filter, the imaging lens, the pair of cylindrical lenses, and the camera are disposed in order along a direction of an optical path from the ultrafast laser to the camera.

8. The method of claim 6, wherein the scanning module further comprises a first lens and a second lens disposed between the scanning mirror and the diffraction grating, and the scanning mirror, the first lens, the second lens, and the diffraction grating are disposed in order along a direction of the optical path from the ultrafast laser to the camera.

9. The method of claim 8, further comprising a third lens, and a fourth lens, wherein the diffraction grating, the third lens, the fourth lens, and the objective lens are disposed in order along a direction of the optical path from the ultrafast laser to the camera.

10. The method of claim 6, further comprising a first lens and a second lens disposed between the first mirror and the scanning mirror, wherein the first lens is configured to adjust the incident light beam size, and the second lens is configured to reshape the incident light beam intensity distribution in the y-direction to obtain an uniform line beam, and the first mirror, the second lens, and the scanning mirror are disposed in order along a direction of the optical path from the ultrafast laser to the camera.

11. The method of claim 10, further comprising a first cylindrical lens and a second cylindrical lens disposed between the second lens and the scanning mirror and configured to collimate the incident light beam in x- and y-direction, wherein the second lens, the first cylindrical lens, the second cylindrical, and the scanning mirror are disposed in order along a direction of the optical path from the ultrafast laser to the camera.

12. The method of claim 11, wherein the scanning module further comprises a third cylindrical lens disposed between the second cylindrical lens and the scanning mirror, wherein the second cylindrical lens, the third cylindrical lens, and the scanning mirror are disposed in order along a direction of the optical path from the ultrafast laser to the camera.

13. The method of claim 6, wherein the scanning mirror is a resonant-scanning mirror.

14. The method of claim 13, wherein the scanning module further comprises a parabolic concave mirror, wherein the resonant-scanning mirror, the parabolic concave mirror, and the diffraction grating are disposed in order along a direction of the optical path from the ultrafast laser to the camera.

15. The method of claim 6, further comprising a bandpass emission filter disposed between the short-pass emission filter and the objective lens, wherein the short-pass emission filter, the bandpass emission filter, and the objective lens are disposed in order along a direction of the optical path from the ultrafast laser to the camera.

16. The method of claim 6, wherein capturing the fluorescence image of the blinking fluorophore-labeled sample by the microscopy system comprises detecting fluorescence switching between the blinking fluorescence signal of pattern fluorescence-on and fluorescence-off.

17. The method of claim 6, the blinking fluorophore comprises the fluorophore with the blinking fluorescence signal generated by at least one approach selected from the group consisting of spontaneously blinking fluorescence, photoswitchable fluorescence, or transient binding.
